(19) United States
(12) Patent Application Publication
(10) Pub. No.: US 2013/0004617 A1
(43) Pub. Date: Jan. 3, 2013

(54) COACERVATE COMPLEXES, METHODS AND FOOD PRODUCTS

(75) Inventors: Naijie ZHANG, Ridgefield, CT (US); William MUTILANGI, Peekskill, NY (US)

(73) Assignee: PepsiCo, Inc., Purchase, NY (US)

(21) Appl. No.: 13/175,451

(22) Filed: Jul. 1, 2011

(51) Int. Cl. A23L 1/30; A23L 2/42; A23L 1/302; A23L 1/305; A23L 1/22; A23L 2/40; A23L 1/053; A23L 1/035; C11B 5/00; A23L 1/222

(52) U.S. Cl. 426/72; 426/541

(57) ABSTRACT

Complex coacervates incorporating one or more hydrophobic substances are provided, that are stable in certain aqueous systems and food products. The coacervates may be used as an ingredient in food products, e.g., in beverages, dry foods, and semi-moist foods. Methods for producing the complex coacervates and food products are also disclosed herein.

### TECHNICAL FIELD OF THE INVENTION

The present invention relates to the field of food products and protecting an edible hydrophobic substance from hydrolysis and oxidation in a food product, more particularly to complex coacervates containing hydrophobic substances and to food products comprising such complex coacervates.

### BACKGROUND OF THE INVENTION

Certain hydrophobic substances are desirable as ingredients in food products, such as in, for example, beverages. In some cases the hydrophobic substance does not have an acceptable taste or taste profile or is not sufficiently stable in the intended food, e.g., in an acidic environment. Examples of such hydrophobic substances include omega-3 fatty acids, water-insoluble flavorants, water-insoluble vitamins, etc. Certain hydrophobic substances have been discovered to have beneficial health effects. For example, omega-3 fatty acids form an important part of the human diet. Eicosapentaenoic acid (EPA) and docosahexaenoic acid (DHA), long-chain forms of omega-3 fatty acids, are believed in many cases to offer health benefits and it has been suggested that consumption of omega-3 fatty acids should be increased.

Hydrophobic substances have been incorporated directly into an aqueous system as a solution (with a compatible solvent), extract, emulsion, or micellular dispersion (a so-called microemulsion). All of these approaches can serve to disperse a hydrophobic substance in an aqueous system and in a food product, such as a beverage or semi-moist food, e.g., a snack bar. They may not, however, provide adequate protection against hydrolysis and oxidation of the hydrophobic substance. Commercially available fish oils can be high in omega-3 fatty acids, and in some cases are “encapsulated,” but these commercially available fish oils have not proven adequately stable in all food contexts, e.g., physically or taste-stable in acidic beverage products. This can result in negative changes to the food product, such as unpleasant fishy flavors and aromas after ingestion, particularly a fishy aftertaste caused by belching fish oil from the stomach. Additionally, omega-3 fatty acids, as well as many water-insoluble flavorants, water-insoluble vitamins, etc. are unstable to degradation, e.g., by oxidation or hydrolysis, when exposed to air, water and/or light.

It would be desirable to provide edible compositions suitable for use in food products, which compositions incorporate one or more desirable hydrophobic substances, e.g., one or more omega-3 fatty acids, water-insoluble flavorants, water-insoluble vitamins, etc. It also would be desirable to provide food products incorporating such edible compositions. At least certain of the embodiments of the new compositions disclosed below can reduce or eliminate the unpleasant taste and odor of the one or more incorporated hydrophobic substances when used as an ingredient in a food product suitable for consumption by a human or animal. At least certain of the embodiments of the new compositions disclosed below provide hydrophobic substances in a stable form suitable for use in foods, e.g., beverage products such as beverage concentrates or syrups, ready to drink beverages, etc., and semi-moist foods such as snack bars. In at least some embodiments the hydrophobic substance is stable to oxidation and hydrolysis during the shelf life of the food product. In at least some embodiments the hydrophobic substance is stable to oxidation and hydrolysis in an acidic food product at pH values down to pH 5.0, and in some embodiments down to pH 4.0, and in some embodiments down to pH 3.0. Additional features and advantages of some or all of the products and methods disclosed here will be apparent to those who are skilled in food technology given the benefit of the following summary and description of exemplary, non-limiting examples.

### SUMMARY

A first aspect of the invention is directed to edible delivery systems for hydrophobic substances, which delivery systems may be incorporated into food products, such as, for example, an acidic beverage, dairy, or juice product. The delivery systems comprise a hydrophobic substance (which should be understood to comprise essentially only one or a combination of substances) encapsulated in complex coacervates. The complex coacervates are formed by combining a solution of anionic polymer with the hydrophobic substance to form an emulsion, and subsequently adding a cationic polymer to form complex coacervates. Water soluble antioxidant is added prior to forming the first emulsion. For example, water soluble antioxidant can be added to the anionic polymer solution after or prior to adding the hydrophobic substance, but water soluble antioxidant can be added, also or instead, to the hydrophobic substance before the hydrophobic substance is added to the solution of anionic polymer. The edible delivery systems for hydrophobic substances disclosed here can reduce or eliminate oxidation of the hydrophobic substances, e.g., in acidic beverages or other acidic food products, and negative organoleptic effects of the encapsulated hydrophobic substance(s), e.g., off flavor, unpleasant aroma, etc.

In another aspect, an aqueous dispersion of complex coacervates is provided. The aqueous dispersion of complex coacervates is prepared by preparing a solution of at least one anionic polymer, adding at least one hydrophobic substance to the solution of anionic polymer, high shear mixing to form an emulsion, adding at least one cationic polymer to the emulsion, and high shear mixing to form an oil-in-water emulsion of complex coacervates. Water soluble antioxidant is added prior to forming the first emulsion. For example, antioxidant can be added to the anionic polymer solution after or prior to adding the hydrophobic substance, but water soluble antioxidant can be added, also or instead, to the hydrophobic substance before the hydrophobic substance is added to the solution of anionic polymer. Optionally, stabilizer is included in the emulsion of complex coacervates. For example, stabilizer may be added to the hydrophobic substance before the hydrophobic substance is combined with the anionic polymer. Stabilizer may be added, instead or also, to the anionic polymer before combining with the hydrophobic substance. In certain exemplary embodiments, i.e., non-limiting examples or embodiments, of the emulsion of complex coacervates disclosed here, the at least one hydrophobic substance may be selected from lipids, water-insoluble vitamins, water-insoluble sterols, water-insoluble flavonoids, flavors, essential oils, and combinations thereof. In certain embodiments the at least one anionic polymer may be selected from gum arabic, pectin, carrageenan, ghatti gum, xanthan gum, agar, modified starch, alginate, carboxyl methyl cellulose (CMC), Q-200 (National Starch) or any combination thereof. In certain embodiments the at least one cationic polymer may be selected from whey protein, hydrolyzed protein, lauric arginate, polylysine, casein or any combination thereof. In certain exemplary embodiments a water soluble antioxidant may be added to the solution of the anionic polymer prior to emulsifying with the at least one hydrophobic substance. In certain exemplary embodiments a water soluble antioxidant may be added to the hydrophobic substance before it is combined with the anionic polymer solution. In certain exemplary embodiments a stabilizer may be added to the hydrophobic substance before combining it with the at least one anionic polymer. In certain exemplary embodiments the at least one hydrophobic substance is omega-3 fatty acid (either alone or with other hydrophobic substances), the anionic polymer is gum arabic (either alone or with other anionic polymers), and the cationic polymer is whey protein (either alone or with other cationic polymers). In certain exemplary embodiment the at least one hydrophobic substance is omega-3 fatty acid, the at least one anionic polymer is gum arabic, and the at least one cationic polymer is whey protein. The water soluble antioxidant can be, e.g., plant derived antioxidants, such as those derived from blackberries, water soluble polyphenols, vitamin C, or any combination thereof. Stabilizers can be, e.g., sucrose ester, triglycerides, lecithin, ester gum, or any combination thereof.

In another aspect, a food product is provided comprising an aqueous dispersion of complex coacervates as disclosed above. In certain exemplary embodiments the aqueous dispersion of complex coacervates is provided by preparing a solution of at least one anionic polymer, adding at least one hydrophobic substance to the anionic polymer, high shear mixing to form an emulsion, adding at least one cationic polymer to the emulsion, and high shear mixing to form an aqueous dispersion of complex coacervates. Water soluble antioxidant is added prior to forming the first emulsion. For example, water soluble antioxidant can be added to the anionic polymer solution after or prior to adding the hydrophobic substance, but water soluble antioxidant can be added, also or instead, to the hydrophobic substance before the hydrophobic substance is added to the solution of anionic polymer. Optionally, stabilizer is included in the emulsion of complex coacervates. For example, stabilizer may be added to the hydrophobic substance before the hydrophobic substance is combined with the anionic polymer. Stabilizer may be added, instead or also, to the anionic polymer before combining with the hydrophobic substance. The food product is provided by combining a second food ingredient with the aqueous dispersion of complex coacervates.

In certain exemplary embodiments the food product is a beverage, e.g., a carbonated soda beverage. In certain embodiments the food product has a pH of 3.0 to pH 7.0, e.g., a pH less than 3.5.

In another aspect, a method for preparing an aqueous dispersion of complex coacervates is provided, comprising preparing a solution of at least one anionic polymer, adding at least one hydrophobic substance to the anionic polymer solution, high shear mixing to form an emulsion, adding at least one cationic polymer to the emulsion, and high shear mixing to form an aqueous dispersion of complex coacervates. Water soluble antioxidant is added prior to forming the first emulsion. For example, antioxidant can be added to the anionic polymer solution after or prior to adding the hydrophobic substance, but water soluble antioxidant can be added, also or instead, to the hydrophobic substance before the hydrophobic substance is added to the solution of anionic polymer. Optionally, stabilizer is included in the emulsion of complex coacervates. For example, stabilizer may be added to the hydrophobic substance before the hydrophobic substance is combined with the anionic polymer. Stabilizer may be added, instead or also, to the anionic polymer before combining with the hydrophobic substance.

In certain embodiments of the methods disclosed here for preparing an aqueous dispersion of complex coacervates, the at least one hydrophobic substance may be selected from lipids, water-insoluble vitamins, water-insoluble sterols, water-insoluble flavonoids, flavors, and essential oils. In certain embodiments the at least one anionic polymer may be selected from gum arabic, pectin, carrageenan, ghatti gum, xanthan gum, agar, modified starch, alginate, carboxyl methyl cellulose (CMC), Q-200 (National Starch) or the combination thereof. In certain embodiments the at least one cationic polymer may be selected from hydrolyzed protein, lauric arginate, polylysine, casein. In certain exemplary embodiments an antioxidant is added to the anionic polymer solution prior to adding the hydrophobic substance, e.g., any one or more of the antioxidants mentioned above. In certain exemplary embodiments stabilizer is added to the hydrophobic substance before adding the at least one anionic polymer, e.g., any one or more of the stabilizers mentioned above. In an exemplary embodiment the at least one hydrophobic substance is omega-3 fatty acid, the at least one anionic polymer is gum arabic, and the at least one cationic polymer is whey protein. In another exemplary embodiment the at least one hydrophobic substance is omega-3 fatty acid, the anionic polymer is gum arabic, the cationic polymer is whey protein, the antioxidant is vitamin C, and the stabilizer is sucrose ester containing triglycerides.

In another aspect, a method is provided for preparing a food product comprising an aqueous dispersion of complex coacervates. A solution of at least one anionic polymer is prepared. At least one hydrophobic substance is added to the solution of the at least one anionic polymer. High shear mixing forms an emulsion. At least one cationic polymer is added to the emulsion. High shear mixing forms an aqueous dispersion of complex coacervates. The aqueous dispersion of complex coacervates is combined with at least one other food ingredient to form the food product. Water soluble antioxidant is added prior to forming the first emulsion. For example, antioxidant can be added to the anionic polymer solution after or prior to adding the hydrophobic substance, but water soluble antioxidant can be added, also or instead, to the hydrophobic substance before the hydrophobic substance is added to the solution of anionic polymer. Optionally, stabilizer is included in the emulsion of complex coacervates. For example, stabilizer may be added to the hydrophobic substance before the hydrophobic substance is combined with the anionic polymer. Stabilizer may be added, instead or also, to the anionic polymer before combining with the hydrophobic substance.

In at least certain exemplary embodiments the complex coacervates disclosed here (also referred to here in the alternative and interchangeable as oil-containing complex coacervates, complex coacervates containing hydrophobic substance, etc.) and food products incorporating them as an ingredient have been found to have unanticipated, desirable properties. For example, in certain such embodiments, the complex coacervates can remain suspended in aqueous systems, e.g., beverages, beverage concentrates, etc., for a surprisingly long period of time. In certain such embodiments the complex coacervates can remain suspended in acidic aqueous systems, e.g., beverages, beverage concentrates, etc., having a pH value less than pH 5.0, and in some cases less than pH 4.0, and in some cases less than pH 3.5, for a surprisingly long period of time. Furthermore, it was found that in at least some embodiments the complex coacervates effectively protect the hydrophobic substance against oxidation and/or hydrolysis, etc.

In another aspect an edible aqueous dispersion of complex coacervates is prepared by mixing an aqueous anionic polymer solution, water soluble antioxidant, and hydrophobic substance comprising omega 3 fatty acid including at least one of EPA and DHA, to form an emulsion. The mixing comprises high shear mixing below 40° C. In some embodiments the temperature is kept below 30° C. and in some embodiments it is kept below 25° C. The water soluble antioxidant is added prior to the high shear mixing forming the emulsion. The water soluble antioxidant and the controlled temperature can help to protect the EPA and DHA against oxidation during the process. Cationic polymers are added to the emulsion and high shear mixing below 40° C. forms an aqueous dispersion of complex coacervates. In some embodiments the temperature is kept below 30° C. during the high shear mixing to form the aqueous dispersion of complex coacervates, and in some embodiments the temperature is kept below 25° C. The aqueous dispersion of complex coacervates is homogenized below 40° C. to reducing average particle size of the complex coacervates to less than 10 microns, e.g., to an average size between 0.1 micron and 10 microns. In some embodiments of the process and resulting aqueous dispersion, the average particle size of the complex coacervates after homogenization is less than 3.0 microns, e.g., between 0.1 micron and 3 microns, e.g., between 1.0.micron and 3 microns. The anionic polymers may be one type of polymer or a mixture of different anionic polymers, and provide from 1.0 wt. % to 40.0 wt. % of the dispersion of complex coacervates (i.e., before it is added to other food ingredients, such as to make a beverage, beverage concentrate (syrup), semi-moist food products such as a snack bar, etc.). Some exemplary embodiments of the aqueous dispersions of complex coacervates disclosed here and of the disclosed methods for their preparation employ only or essentially only natural ingredients.

The anionic polymers may be one type of polymer or a mixture of different anionic polymers, and in some embodiments the anionic polymers provide from 1.0 wt. % to 40.0 wt. % of the dispersion of complex coacervates, e.g., from 10.0 wt. % to 20.0 wt. % of the dispersion of complex coacervates (e.g., immediately after homogenization prior to the dispersion being incorporated into a beverage or other food). The cationic polymers may be one type of polymer or a mixture of different cationic polymers and in some embodiments provide from 0.05 wt. % to 20.0 wt. % of the dispersion of complex coacervates (again meaning before the addition to other food ingredients), e.g., from 1.0 wt. % to 10.0 wt. % of the dispersion of complex coacervates. The water soluble antioxidant may be one antioxidant or a mixture of different antioxidants and provides from 0.1 wt. % to 20.0 wt. % of the dispersion of complex coacervates, e.g., from 1.0 wt. % to 5 wt. %. In some embodiments the water soluble antioxidant provides from 1.0 wt. % to 5.0 wt. % of the dispersion of complex coacervates. The hydrophobic substance may be one or a mixture of different hydrophobic substances and provides from 0.5 wt. % to 20.0 wt. % of the dispersion of complex coacervates. In some embodiments the hydrophobic substance provides from 5.0 wt. % to 10.0 wt. % of the dispersion of complex coacervates. In some embodiments the hydrophobic substance comprises water insoluble antioxidant, e.g., butylated hydroxytoluene, butylated hydroxyanisole, tert-butyhydroquinone, quercetin, tocopherol, or any combination thereof. The hydrophobic substance may contain omega-3 fatty acids (sometimes referred to here as “O3FA”), e.g., flax seed, linseed oil, or other seed oil, fish oil, algae oil, seaweed oil, etc. or any combination of such oils. In certain exemplary embodiments the hydrophobic substance contains 20.0 wt. % to 35.0 wt. % combined of the O3FAs EPA and DHA. In some embodiments the hydrophobic substance contains EPA and/or DHA in combined amount providing less than 5.0 wt. % EPA and DHA combined in the dispersion of complex coacervates, e.g., from 1.0 wt. % up to 3.0 wt. % EPA and DHA combined in the dispersion of complex coacervates.

In some embodiments the temperature is kept below 40° C., or below 30° C. or even below 25° C. during preparation of the complex coacervates, e.g., at all times during the preparation of the edible aqueous dispersion of complex coacervates. Homogenising the aqueous dispersion of complex coacervates can be done in accordance with known techniques and equipment, e.g., at pressure greater than 3000 psig. Homogenising the aqueous dispersion of complex coacervates reduces average particle size of the complex coacervates, e.g., to more than 0.1 micron, e.g., to less than 10.0 microns, e.g., to 0.3 to 1.0 microns.

In certain exemplary embodiments of the aqueous dispersion of complex coacervates in accordance with this aspect of the disclosure, the hydrophobic substance consists essentially of fish oil or other natural oil containing at least 10.0 wt. % EPA and DHA, e.g., at least 20.0 wt. %, e.g., up to 35.0 wt. % or even up to 40.0 wt. % EPA and DHA combined, and optionally also containing water insoluble antioxidant, where the EPA and DHA collectively provide from 0.1 wt. % to 5.0 wt. % of the dispersion of complex coacervates, e.g., from 1.0 wt. % to 3.0 wt. % of the dispersion of complex coacervates. In certain exemplary embodiments, the dispersion of complex coacervates has less than 0.05 wt. % free oil, e.g., less than 0.01 wt. % free oil. As used here, the term “free oil” means oil in the dispersion of complex coacervates that is not encapsulated.

In certain exemplary embodiments the cationic polymers are selected from alpha-lactoglobulin, beta-lactoglobulin, whey protein isolate, whey protein isolate and any combination thereof, collectively providing from 0.05 wt. % to 10.0 wt. % of the dispersion of complex coacervates.

In accordance with another aspect, the aqueous dispersions of complex coacervates disclosed here are employed in a food product, e.g., a beverage, semi-moist snack bar, etc. The aqueous dispersion of complex coacervates can be mixed with one or more other food ingredients, including, e.g., water, flavoring, carbonation, preservative, vitamins, minerals, electrolytes, fruit juice, vegetable juice, flavour modifiers, acidulants, clouding agents, weighting agents, or any combination of such other ingredients (meaning one or more of each or any such ingredients). Advantageously, at least certain embodiments of the aqueous dispersions of complex coacervates disclosed here do not require a weighting agent. Typically, weighting agents are used, for example, to help keep a lighter-than water ingredient (e.g., an oil or oil-containing ingredient) in suspension in a beverage. At least certain embodiments of the aqueous dispersions of complex coacervates disclosed here are found to remain in suspension in a beverage without the aid of a weighting agent. Thus, at least certain embodiments of the beverages disclosed here comprising certain embodiments of the aqueous dispersions of complex coacervates disclosed here contain no weighting agent for the aqueous dispersion of complex coacervates, and in some cases no weighting agent at all. Advantageously, at least certain embodiments of the aqueous dispersions of complex coacervates disclosed here are found to serve as a clouding agent in certain beverage formulations. The cost and complexity of adding a separate clouding agent can therefore be avoided where such embodiments of the aqueous dispersions of complex coacervates disclosed here are used in such beverages. Thus, at least certain embodiments of the beverages disclosed here comprising certain embodiments of the aqueous dispersions of complex coacervates disclosed here contain no clouding agent other than such aqueous dispersion of complex coacervates.

These and other aspects, advantages and features of the present invention herein disclosed will become apparent through reference to the following detailed description. Furthermore, it is to be understood that the features of the various embodiments described herein are not mutually exclusive and exist in various combinations and permutations in other embodiments.

### BRIEF DESCRIPTION OF THE DRAWINGS

In the drawings, like reference characters generally refer to the same parts throughout the different views. Also, the drawing is not necessarily to scale, emphasis instead generally being placed upon illustrating the principles of the invention. In the following description, various embodiments of the present invention are described with reference to the following drawing, in which:

FIG. 1 depicts a schematic of a coacervate complex exemplary of at least certain embodiments of those disclosed here.

### DETAILED DESCRIPTION OF CERTAIN EMBODIMENTS

Various examples and embodiments of the inventive subject matter disclosed here are possible and will be apparent to the person of ordinary skill in the art, given the benefit of this disclosure. In this disclosure reference to “certain exemplary embodiments” (and similar phrases) means that those embodiments are merely non-limiting examples of the inventive subject matter and that there likely are other alternative embodiments which are not excluded. Unless otherwise indicated or unless otherwise clear from the context in which it is described, alternative elements or features in the embodiments and examples below and in the Summary above are interchangeable with each other. That is, an element described in one example may be interchanged or substituted for one or more corresponding elements described in another example. Similarly, optional or non-essential features disclosed in connection with a particular embodiment or example should be understood to be disclosed for use in any other embodiment of the disclosed subject matter. More generally, the elements of the examples should be understood to be disclosed generally for use with other aspects and examples of the devices and methods disclosed herein. A reference to a component or ingredient being operative, i.e., able to perform one or more functions, tasks and/or operations or the like, is intended to mean that it can perform the expressly recited function(s), task(s) and/or operation(s) in at least certain embodiments, and may well be operative to perform also one or more other functions, tasks and/or operations. While this disclosure includes specific examples, including presently preferred modes or embodiments, those skilled in the art will appreciate that there are numerous variations and modifications within the spirit and scope of the invention as set forth in the appended claims. Each word and phrase used in the claims is intended to include all its dictionary meanings consistent with its usage in this disclosure and/or with its technical and industry usage in any relevant technology area. Indefinite articles, such as “a,” and “an” and the definite article “the” and other such words and phrases are used in the claims in the usual and traditional way in patents, to mean “at least one” or “one or more.” The word “comprising” is used in the claims to have its traditional, open-ended meaning, that is, to mean that the product or process defined by the claim may optionally also have additional features, elements, etc. beyond those expressly recited.

As used here, an “aqueous solvent” is a solvent for the polymers and/or coacervates of the dispersion, that either (i) comprises water together with any other consumable (i.e., edible) solvent, e.g., comprising primarily (i.e., at least 50 wt. %) water, e.g., at least 80 wt. % water, at least 90 wt. % water or at least 99 wt. % water, or (ii) consists essentially of water (e.g., potable spring water, distilled or purified water, tap water or the like).

As used here, the term “high shear mixing” has its ordinary meaning to those skilled in the art. In the case of the high shear mixing of the hydrophobic substance(s) with the initial aqueous polymer solution, it means at least mixing at such speed(s) and/or force level(s) as are effective to form an emulsion of such ingredients. In the case of the high shear mixing with the oppositely charged polymer, it means at least mixing at such speed(s) and/or force level(s) as are effective to form the aqueous dispersion of complex coacervates.

As used here, the term “hydrophobic substance” means either a single hydrophobic substance or multiple different hydrophobic substances, e.g., a mixture of hydrophobic substances. As noted above, the hydrophobic substance may in some embodiments of the aqueous dispersion of complex coacervates be fish oil, seed oil, algae oil, seaweed oil or any combination of them.

As used here, “fish oil” has its ordinary meaning and includes, at least any oily hydrophobic substance obtained from fish. Similarly, seed oil has its ordinary meaning and includes, at least any oily hydrophobic substance obtained from plant seeds, e.g., flax seed oil. Algae oil includes at least any oily hydrophobic substance obtained from algae. Seaweed oil includes at least any oily hydrophobic substance obtained from seaweed.

As used here, the term “clouding agent” has its ordinary meaning to those skilled in the art. In general, it means a beverage ingredient that provides cloudiness or opacity or the like to the beverage. It is an advantage of at least certain beverages in accordance with this disclosure, that are intended to be clouded or non-clear, that the dispersion of complex coacervates can provide the desired clouding effect. Thus, in such embodiments the cost and complexity of adding a separate clouding agent is advantageously avoided. It is an advantage of at least certain beverages in accordance with this disclosure, that the cost and complexity of a weighting agent is advantageously avoided. That is, in at least certain embodiments the complex coacervates remain homogenously dispersed or suspended in the beverage without a weighting agent.

As used here, the term “weighting agent” has its ordinary meaning to those skilled in the art. In general, it means an ingredient combined with a second ingredient in a beverage to aid in keeping such second ingredient homogenously dispersed or suspended in the beverage. As used here, the term “natural ingredient” means an ingredient that is natural as that term is defined by the applicable regulations of the Food and Drug Administration of the government of the United States of America on the effective filing date (i.e., the priority date) of this application. In some case, reference is made to “at least one” of a particular ingredient, such as at least one hydrophobic substance or at least one antioxidant or at least one cationic polymer. In all such cases, the term “at least one” is used to emphasize that one or more such species may be used. Such uses are not intended to mean, and should not be construed as implying, that a reference elsewhere to any such ingredient without the prefatory “at least one” means one and only one species of such ingredient.

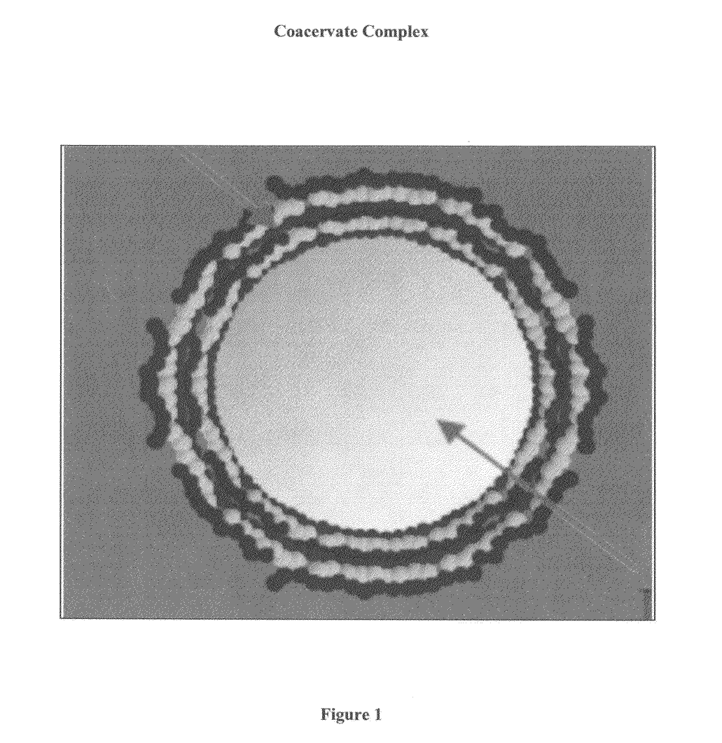

As used herein, “complex coacervate” is defined as an identifiable discrete particle containing one or more hydrophobic substances, e.g., oil, water-insoluble vitamins, flavors, etc., that are enveloped by a shell comprising at least two oppositely charged polymers (that is, cationic polymers of at least one type and anionic polymers of at least one type) that substantially coats and protects the particles of hydrophobic substance from hydrolysis, oxidation, and degradation. Suitable polymers include not only traditional polymers, but also oligomers and the like. In certain exemplary embodiments, the complex coacervates are substantially non-agglomerated, but comprise a single shell encapsulating a single core. FIG. 1 shows an exemplary, simplified complex coacervate having a hydrophobic substance, e.g., fish oil or purified or concentrated omega 3 fatty acids in an inner shell or layer formed primarily by anionic polymer, and an outer shell or layer formed primarily by cationic polymer.

As used herein, a “hydrophobic substance” refers to a water immiscible material such as an oil, a lipid, a water-insoluble vitamin (e.g. á-tocopherol), a water-insoluble sterol, a water-insoluble flavonoid, a flavor or an essential oil. The oil employed in accordance with the present invention can be a solid, a liquid or a mixture of both.

As used herein a “lipid” encompasses any substance that contains one or more fatty acid residues, including free fatty acids. Thus, the term “lipid” encompasses, for instance, triglycerides, diglycerides, monoglycerides, free fatty acids, phospholipids or a combination of any of them.

As used herein a “fatty acid” encompasses free fatty acids as well as fatty acid residues. Whenever reference is made herein to a weight percentage of fatty acids, this weight percentage includes free fatty acids as well as fatty acid residues (e.g. fatty acid residues contained in triglycerides). Further, as used herein a “polyunsaturated fatty acid” (PUFA) encompasses any fatty acid containing 2 or more double bonds in the carbon chain.

Aspects of the edible delivery systems disclosed here for hydrophobic substances relate to complex coacervates. The delivery systems provide a stable composition suitable for inclusion in food products. That is, the complex coacervates in at least certain embodiments of the delivery systems are sufficiently stable for shelf-storage prior to use in food, e.g., for storage as long as 3 months, or even 9 months prior to use in making food products. In at least certain embodiments, acidic food products comprising the complex coacervates are shelf-storage for storage as long as 3 months, or even 9 months prior to consumption. The complex coacervates can reduce or eliminate the unpleasant taste and odor of many hydrophobic substances, such as fish oil, and reduce degradation, e.g. by oxidation or hydrolysis, of some otherwise unstable hydrophobic substances. The complex coacervates may be incorporated into a food product associated with health benefits, for example orange juice, dairy, to provide enhanced nutritional value. Additionally, the complex coacervates may be incorporated into other food products, for example carbonated soft drinks By encapsulating such hydrophobic substances in complex coacervates, possible negative visual and physical changes to the food product may be reduced or avoided during a storage period. The resulting food product is appealing to the consumer, as well as being stable and having an adequate shelf life.

In certain exemplary embodiments, complex coacervates are provided in an aqueous dispersion. As used herein, an “aqueous dispersion” is defined as particles distributed throughout a liquid water medium, e.g., as a suspension, a colloid, an emulsion, a sol, etc. The liquid water medium may be pure water or may be a mixture of water with at least one water-miscible solvent, such as, for example, ethanol or other alcohols, propylene glycol, glycerin etc. In certain exemplary embodiments, there may be a substantial concentration of water-miscible solvent in the aqueous dispersion of the complex coacervates, such as, between about 1% and about 20% by volume, for example 5%, 10%, or 15%. In other exemplary embodiments, the complex coacervates are diluted into a food product wherein the concentration of water-miscible solvent is negligible. In other exemplary embodiments, the complex coacervates are combined with one or more solid food ingredients, wherein there is little or no free water, e.g., a snack bar, etc. In certain exemplary embodiments an aqueous solution is prepared comprising at least one anionic polymer. The at least one anionic polymer comprises, for example, gum arabic, modified starches, pectin, Q-200, carrageenan, alginate, xanthan gum, modified celluloses, carboxymethylcellulose, gum acacia, gum ghatti, gum karaya, gum tragacanth, locust bean gum, guar gum, psyllium seed gum, quince seed gum, larch gum (arabinogalactans), stractan gum, agar, furcellaran, gellan gum, or a combination of any of them. In an exemplary embodiment the anionic polymer comprises gum arabic. In certain embodiments the solution of at least one anionic polymer comprises a solution of gum arabic. In certain exemplary embodiments, the solution of the at least one anionic polymer is subjected to high shear mixing. In certain embodiments the high shear mixing may occur for 2-5 minutes at a temperature maintained within the range of 5° C. to 25° C.

In certain exemplary embodiments at least one hydrophobic substance is added to the solution of the at least one anionic polymer under high shear mixing at a temperature between 5-25° C., followed by adding whey protein to form an oil-in-water coacervate complex emulsion. Subsequently, the coacervate emulsion is homogenized. In certain exemplary embodiments the coacervate emulsion is homogenized at a pressure maintained within the range of 3000-4500 psi. In certain exemplary embodiments the coacervate emulsion is homogenized at 10-30° C. In certain exemplary embodiments the coacervate emulsion is homogenized for 1-2 passes to form a fine, homogeneous emulsion. The final coacervate emulsion contains, e.g., 3-15 wt. % hydrophobic substance. In certain embodiments the hydrophobic substance is, for example, an oil droplet. In exemplary embodiments the oil droplet is a lipophilic nutrient, e.g., fish oil or omega-3 fatty acids or a water-insoluble flavorant.

In certain exemplary embodiments, the lipophilic nutrients include fat soluble vitamins, (e.g., vitamins A, D, E, and K), tocotrienols, carotenoids, xanthophylls, (e.g., lycopene, lutein, astaxanthin, and zeazanthin), fat-soluble nutraceuticals including phytosterols, stanols and esters thereof, Coenzyme Q10 and ubiquinol, hydrophobic amino acids and peptides, essential oils and extracts, and fatty acids. Fatty acids may include, for example, conjugated linolenic acid (CLA), omega-6 fatty acids, and omega-3 fatty acids. Suitable omega-3 fatty acids include, e.g., short-chain omega-3 fatty acids such as alpha-linolenic acid (ALA), which are derived from plant sources, for example flaxseed, and long-chain omega-3 fatty acids such as eicosapentaenoic acid (EPA) and docosahexaenoic acid (DHA). The long-chain omega-3 fatty acids can be derived from, for example, marine or fish oils. Such oils can be extracted from various types of fish or marine animals, such as anchovies, capelin, cod, herring, mackerel, menhaden, salmon, sardines, shark and tuna, or from marine vegetation, such as micro-algae, or a combination of any of them. Other sources of omega-3 fatty acids include liver and brain tissue and eggs.

In certain exemplary embodiments, the water-insoluble flavorant is any substance that provides a desired flavor to a food or beverage product, which does not substantially dissolve in water (e.g., non-polar, hydrophobic substances such as lipids, fats, oils, etc.). The flavorant may be a liquid, gel, colloid, or particulate solid, e.g., an oil, an extract, an oleoresin, or the like. Exemplary water-insoluble flavorants include, but are not limited to, citrus oils and extracts, e.g. orange oil, lemon oil, grapefruit oil, lime oil, citral and limonene, nut oils and extracts, e.g. almond oil, hazelnut oil and peanut oil, other fruit oils and extracts, e.g. cherry oil, apple oil and strawberry oil, botanical oils and extracts, e.g., coffee oil, mint oil, vanilla oil, and combinations of any of them.

In certain embodiments a water soluble antioxidant is added to the solution of the anionic polymer prior to the addition of the at least one hydrophobic substance. In certain embodiments the water soluble antioxidant can be, e.g., plant derived antioxidants, such as those derived from blackberries, water soluble polyphenols, vitamin C, or any combination thereof. In certain embodiments the hydrophobic substance may further comprise a water insoluble antioxidant. In certain embodiments the water insoluble antioxidant may be selected from butylated hydroxytoluene, butylated hydroxyanisole, tert-butylhydroquinone, quercetin, tocopherol,

In certain embodiments a stabilizer is added to the emulsion containing the at least one hydrophobic substance and the at least one anionic polymer before the at least one cationic polymer is added. The stabilizer may be selected from sucrose ester, triglycerides, lecithin, ester gum, and combinations of any of them. In an exemplary embodiment the stabilizer is sucrose ester containing triglycerides.

In certain exemplary embodiments at least one cationic polymer is added to the emulsion containing the at least one hydrophobic substance and the at least one anionic polymer, and in alternative embodiments, an antioxidant and/or a stabilizer. The final coacervate emulsion may contain, for example, 0.1-10 wt. % cationic polymer. The mixture of the at least one cationic polymer and the emulsion containing the at least one hydrophobic substance and the at least one anionic polymer can be homogenized using high pressure to form an aqueous solution of complex coacervates. The homogenization proceeds, for example, at 3000 to 4500 psi for 1-2 passes. The at least one cationic polymer comprises, for example, proteins such as dairy proteins, including whey proteins, caseins and fractions thereof, gelatin, corn zein protein, bovine serum albumin, egg albumin, grain protein extracts, e.g. protein from wheat, barley, rye, oats, etc., vegetable proteins, microbial proteins, chitosan, legume proteins, proteins from tree nuts, proteins from ground nuts, hydrolyzed protein, lauric arginate, polylysine and the like, or combinations of any of them. In an exemplary embodiment the cationic polymer is whey protein. In certain embodiments whey protein may be selected from β-lactoglobulin (β-LG), whey protein isolate (WPI), whey protein concentrated, hydrolyzed protein, lauric arginate, polylysine or combinations thereof. β-lactoglobulin (β-LG) provides good performance and good emulsion stability in certain embodiments. β-lactoglobulin (β-LG) is the major whey protein of ruminant species. Its amino-acid sequence and 3-dimentional structure can efficiently bind small hydrophobic molecules such as omega-3 fatty acid, resulting in good protection against hydrolysis and oxidation.

In certain embodiments the complex coacervates have a negative zeta potential, that is, the outside of the complex coacervate shell displays a net negative charge. In certain exemplary embodiments the shell includes a net positive charged (cationic) polymer and a net negative charged (anionic) polymer. It is currently believed that the net charge of each polymer is dependent on the pH of the environment and the isoelectric point of each polymer, which is in turn dependent on the density of ionizable groups in each polymer and the pKa values of those groups. Thus, disclosure here of complex coacervates comprising cationic and anionic polymers refers to the charge of the polymers in the environment or reaction conditions used for formation of the complex coacervates. Complex coacervates of the type used here are presently understood to be stabilized at least in part by the electrostatic attraction between the oppositely charged polymers.

In certain exemplary embodiments, the complex coacervates comprise, for example, 3-15 wt. % of the at least one hydrophobic substance; 5-30 wt. % of the at least one anionic polymer; and 0.1-10 wt. % of the at least one cationic polymer. In alternative embodiments, the complex coacervates comprise, for example, 3-15 wt. % of the at least one hydrophobic substance; 0.05-5 wt. % of the antioxidant; 5-30 wt. % of the at least one of the anionic polymer; 0.1-10 wt. % of the at least one of the cationic polymer; and 0.1-5 wt. % of the stabilizer.

In certain exemplary embodiments, the oil droplets contain, for example, at least 3 wt. % or, alternatively 10 wt. %, of one or more polyunsaturated fatty acids selected from omega-3 fatty acids, omega-6 fatty acids and combinations of any of them. In certain embodiments, the one or more polyunsaturated fatty acids contain ALA, DHA, EPA, CLA, and combinations of any of them. In alternative embodiments, the oil droplets contain, for example, at least 50 wt. %, at least 70 wt. %, or at least 80 wt. % of lipids.

In certain exemplary embodiments, the particle size of complex coacervates of the present invention has an average diameter in the range of, for example, 0.3-1.2 μm. In certain embodiments, the oil droplets in the complex coacervates have a diameter in the range of, for example, 1.0 μm or 3.0 μm.

In certain exemplary embodiments, the aqueous dispersion of the present invention may contain other dispersed components in addition to the complex coacervates. In certain embodiments, the dispersion contains less than 20 wt. % of one or more dispersed edible components, including the dispersed complex coacervates.

In certain exemplary embodiments, the complex coacervates are not substantially additionally stabilized, for example by substantial gelling or substantial hardening of the complex coacervates.

In certain exemplary embodiments, the aqueous dispersion of complex coacervates is maintained as an aqueous dispersion. In alternative embodiments, the aqueous dispersion of complex coacervates is, for example, spray dried, freeze dried, drum dried, or bed dried. If maintained as an aqueous dispersion, in certain embodiments, the aqueous dispersion of complex coacervates is treated to protect from microbiological growth. In certain embodiments, the aqueous dispersion of complex coacervates is, for example, pasteurized, aseptically packaged, treated with chemical preservatives, e.g., benzoates, sorbates, etc., treated with acid, e.g., citric acid, phosphoric acid, etc., treated at high temperature and/or carbonated. In an exemplary embodiment, the aqueous dispersion of complex coacervates has minimized contact with air during production, is pasteurized after production, and is stored in a refrigerator with limited contact with light.

In certain exemplary embodiments, a desired amount of hydrophobic substance in the form of the above-described complex coacervates is included in a food product. The amount of complex coacervates, and hence the amount of hydrophobic substance included in the food product, may vary depending on the application and desired taste and nutrition characteristics of the food product. The complex coacervates may be added to the food product in any number of ways, as would be appreciated by those of ordinary skill in the art given the benefit of this disclosure. In certain exemplary embodiments, the complex coacervates are sufficiently mixed in the food product to provide a substantially uniform distribution, for example a stable dispersion. Mixing should be accomplished such that the complex coacervates are not destroyed. If the complex coacervates are destroyed, oxidation of the hydrophobic substance may result. The mixer(s) can be selected for a specific application based, at least in part, on the type and amount of ingredients used, the viscosity of the ingredients used, the amount of product to be produced, the flow rate, and the sensitivity of ingredients, such as the complex coacervates, to shear forces or shear stress.

Encapsulation of hydrophobic substances using the above-described complex coacervates stabilizes the hydrophobic substance by protecting it from degradation by, for example, oxidation and/or hydrolysis. When included in an acidic food product, the complex coacervates can provide a stable dispersion of hydrophobic substances over the shelf life of the food product. Factors that may affect the shelf-life of the complex coacervates include the level of processing the product undergoes, the type of packaging, and the materials used for packaging the product. Additional factors that may affect the shelf life of the product include, for example, the nature of the base formula (e.g., an acidic beverage sweetened with sugar has a longer shelf-life than an acidic beverage sweetened with aspartame) and environmental conditions (e.g., exposure to high temperatures and sunlight is deleterious to ready-to-drink beverages).

In certain exemplary embodiments, the food product is a beverage product. In certain embodiments, the beverage products include ready-to-drink beverages, beverage concentrates, syrups, shelf-stable beverages, refrigerated beverages, frozen beverages, and the like. In exemplary embodiments, the beverage product is acidic, e.g. having a pH within the range below about pH 5.0, in certain exemplary embodiments, a pH value within the range of about pH 1.0 to about pH 4.5, or in certain exemplary embodiments, a pH value within the range of about pH 1.5 to about pH 3.8. In an exemplary embodiment the beverage product has a pH of 3.0. Beverage products include, but are not limited to, e.g., carbonated and non-carbonated soft drinks, fountain beverages, liquid concentrates, fruit juice and fruit juice-flavored drinks, sports drinks, energy drinks, fortified/enhanced water drinks, soy drinks, vegetable drinks, grain-based drinks (e.g. malt beverages), fermented drinks (e.g., yogurt and kefir) coffee beverages, tea beverages, dairy beverages, and mixtures thereof. Exemplary fruit juice sources include citrus fruit, e.g. orange, grapefruit, lemon and lime, berry, e.g. cranberry, raspberry, blueberry and strawberry, apple, grape, pineapple, prune, pear, peach, cherry, mango, and pomegranate. Beverage products include bottle, can, and carton products and fountain syrup applications.

Certain embodiments of other food products include fermented food products, yogurt, sour cream, cheese, salsa, ranch dip, fruit sauces, fruit jellies, fruit jams, fruit preserves, and the like. In certain exemplary embodiments, the food product is acidic, e.g. having a pH value within the range below about pH 5.0, in certain exemplary embodiments, a pH value within the range of about pH 1.0 to about pH 4.5, or in certain exemplary embodiments, a pH value within the range of about pH 1.5 to about pH 3.8. In an exemplary embodiment the food product has a pH of 3.0.

The food product may optionally include other additional ingredients. In certain embodiments, additional ingredients may include, for example, vitamins, minerals, sweeteners, water-soluble flavorants, colorings, thickeners, emulsifiers, acidulants, electrolytes, antifoaming agents, proteins, carbohydrates, preservatives, water-miscible flavorants, edible particulates, and mixtures thereof. In certain embodiments, other ingredients are also contemplated. In exemplary embodiments, the ingredients can be added at various points during processing, including before or after pasteurization, and before or after addition of the complex coacervates.

In at least certain exemplary embodiments, food products disclosed here may be pasteurized. The pasteurization process may include, for example, ultra high temperature (UHT) treatment and/or high temperature-short time (HTST) treatment. The UHT treatment includes subjecting the food or beverage product to high temperatures, such as by direct steam injection or steam infusion, or by indirect heating in a heat exchanger. Generally, after the product is pasteurized, the product can be cooled as required by the particular product composition/configuration and/or the package filling application. For example, in one embodiment, the food or beverage product is subjected to heating to about 185° F. (85° C.) to about 250° F. (121° C.) for a short period of time, for example, about 1 to 60 seconds, then cooled quickly to about 36° F. (2.2° C.) +/10° F. (5° C.) for refrigerated products, to ambient temperature for shelf stable or refrigerated products, and to about 185° F. (85° C.) +/−10° F. (5° C.) for hot-fill applications for shelf-stable products. The pasteurization process is typically conducted in a closed system, so as not to expose the food product to atmosphere or other possible sources of contamination. In alternative embodiments, other pasteurization or sterilization techniques may also be useful, such as, for example, aseptic or retort processing. In addition, multiple pasteurization processes may be carried out in series or parallel, as necessitated by the food product or ingredients.

Food products may, in addition, be post processed. In exemplary embodiments, post processing is typically carried out following addition of the complex coacervates. Post processing can include, for example, cooling the product solution and filling it into a container for packaging and shipping. In certain embodiments, post processing may also include deaeration of the food product to less than 4.0 ppm oxygen, preferably less than 2.0 ppm and more preferably less than 1.0 ppm oxygen. In alternative embodiments deaeration and other post processing tasks may be carried out prior to processing, prior to pasteurization, prior to mixing with the complex coacervates and/or at the same time as adding the complex coacervates. In addition, in certain embodiments, an inert gas (e.g., nitrogen or argon) headspace may be maintained during the intermediary processing of the product and final packaging. Additionally/alternatively, an oxygen or UV radiation barriers and/or oxygen scavengers could be used in the final packaging.

The following examples are specific embodiments of the present invention, but are not intended to limit it.

### EXAMPLES

### Example 1

To 225 g gum arabic solution (20%) 2 g vitamin C was added. Fish oil 15 g (30% EPA/DHA) was added and emulsified at 10-25° C. under high shear mixing to form an oil-in-water emulsion. Subsequently, 60 g solution of β-lactoglobulin (20%) was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage containing omega-3 fish oil. The pH was about 2.9. The pH range of the resultant isotonic beverage may be about 2.5-4.5.

TABLE 1

| | Amount |
|---|---|
| Ingredient | (% by wt.) |
| Water | 95.59% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Emulsion | 0.89% |
| Reb A | 0.015% |
| Vitamin C (Ascorbic Acid) | 0.105% |
| Erythritol | 0.90% |
| Total | 100.000% |

### Example 2

To 225 g gum arabic solution (20%) 1.5 g vitamin C was added. Fish oil 15 g (22% EPA/DHA) containing dissolved 9 g sucrose ester (SAIB-MCT) was added and emulsified at 10-25° C. under high shear mixing to form an oil-in-water emulsion. Subsequently, 60 g solution of beta-lactoglobulin (5%) was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage containing omega-3 fish oil. The pH was about 2.9. The pH range of the resultant isotonic beverage may be about 2.5-4.5.

TABLE 2

| | Amount |
|---|---|
| Ingredient | (% by wt.) |
| Water | 95.23% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Emulsion | 1.24% |
| Reb A | 0.015% |
| Vitamin C (Ascorbic Acid) | 0.105% |
| Erythritol | 0.90% |
| Total | 100.000% |

### Example 3

To 225 g gum arabic solution (20%) 2 g vitamin C was added. Fish oil 15 g (22% EPA/DHA) containing dissolved 10 g sucrose ester (SAIB-MCT) was added and emulsified at 10-25° C. under high shear mixing to form an oil-in-water emulsion. Subsequently, 60 g solution of beta-lactoglobulin (11%) was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage containing omega-3 fish oil. The pH was about 2.9. The pH range of the resultant isotonic beverage may be about 2.5-4.5.

TABLE 3

| | Amount |
|---|---|
| Ingredient | (% by wt.) |
| Water | 95.23% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Emulsion | 1.24% |
| Reb A | 0.015% |
| Vitamin C (Ascorbic Acid) | 0.105% |
| Erythritol | 0.90% |
| Total | 100.000% |

### Example 4

To 225 g gum arabic solution (20%) 2 g vitamin C was added. Fish oil 25.4 g (22% EPA/DHA) dissolved in 17 g sucrose ester (SAIB-MCT) was added and emulsified at 10-25° C. under high shear mixing to form an oil-in-water emulsion. Subsequently, 102 g solution of beta-lactoglobulin (11%) was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage containing omega-3 fish oil. The pH was about 2.9. The pH range of the resultant isotonic beverage may be about 2.5-4.5.

TABLE 4

| | Amount |
|---|---|
| Ingredient | (% by wt.) |
| Water | 95.59% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Emulsion | 0.89% |
| Reb A | 0.015% |
| Vitamin C (Ascorbic Acid) | 0.105% |
| Erythritol | 0.90% |
| Total | 100.000% |

### Example 5

To 225 g gum arabic solution (20%) 2 g vitamin C was added and dissolved. Fish oil 15 g (22% EPA/DHA) containing dissolved 2 g ester gum was added and emulsified at 10-25° C. under high shear mixing to form an oil-in-water emulsion. Subsequently, 35 g solution of beta-lactoglobulin (10%) was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage containing omega-3 fish oil. The pH was about 2.9. The pH range of the resultant isotonic beverage may be about 2.5-4.5.

TABLE 5

| | Amount |
|---|---|
| Ingredient | (% by wt.) |
| Water | 95.37% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Emulsion | 1.11% |
| Reb A | 0.015% |
| Vitamin C (Ascorbic Acid) | 0.105% |
| Erythritol | 0.90% |
| Total | 100.000% |

### Example 6

To 225 g gum arabic solution (20%) with dissolved 6 g vitamin C fish oil 15 g (30% EPA/DHA) was added and emulsified at 10-25° C. under high shear mixing to form an oil-in-water emulsion. Subsequently, 60 g solution of whey protein concentrate (20%) was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage containing omega-3 fish oil. The pH was about 2.9. The pH range of the resultant isotonic beverage may be about 2.5-4.5.

TABLE 6

| | Amount |
|---|---|
| Ingredient | (% by wt.) |
| Water | 95.55% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Emulsion | 0.93% |
| Reb A | 0.015% |
| Vitamin C (Ascorbic Acid) | 0.105% |
| Erythritol | 0.90% |
| Total | 100.000% |

### Example 7

To 225 g gum arabic solution (20%) with dissolved 6 g vitamin C fish oil 15 g (30% EPA/DHA) was added and emulsified at 10-25° C. under high shear mixing to form an oil-in-water emulsion. Subsequently, 60 g solution of hydrolyzed whey protein (20%) was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage containing omega-3 fish oil. The pH was about 2.9. The pH range of the resultant isotonic beverage may be about 2.5-4.5.

TABLE 7

| | Amount |
|---|---|
| Ingredient | (% by wt.) |
| Water | 95.55% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Emulsion | 0.93% |
| Reb A | 0.015% |
| Vitamin C (Ascorbic Acid) | 0.105% |
| Erythritol | 0.90% |
| Total | 100.000% |

### Example 8

### Dairy

To 225 g gum arabic solution (20%) 2 g vitamin C was added. Fish oil 15 g (22% EPA/DHA) was added and emulsified at 10-25° C. under high shear mixing to form an oil-in-water emulsion. Subsequently, 60 g solution of beta-lactoglobulin (20%) was added slowly to form coacervate complex emulsion at pH 3-5. The coacervate emulsion was further mixed for 2 minutes and then homogenized by 1-2 pass under 3000-4500 psi. The coacervate emulsion was added to the protein and dispersed in the protein. Additional ingredients were added in the concentrations (w/w) listed below to make dairy products containing omega-3 fish oil. The pH was about 3.5 and 7.0.

TABLE 8

| | Amount |
|---|---|
| Ingredient | (% by wt.) |
| Water | 89.77% |
| Dry Sucrose | 5% |
| Stabilizers | 0.92% |
| Orange Flavor | 0.500% |
| Coacervate Emulsion | 1.21% |
| Protein Blend | 2.6% |
| Total | 100% |

pH = 3.3; 7.0

### Example 9

To 225 g gum arabic solution (20%) 1.5 g vitamin C was added. Fish oil 15 g (30% EPA/DHA) containing dissolved 9 g canola oil was added and emulsified at 10-25° C. under high shear mixing to form an oil-in-water emulsion. Subsequently, 60 g solution of beta-lactoglobulin (5%) was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage containing omega-3 fish oil. The pH was about 2.9. The pH range of the resultant isotonic beverage may be about 2.5-4.5.

TABLE 9

| | Amount |
|---|---|
| Ingredient | (% by wt.) |
| Water | 95.56% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Emulsion | 0.92% |
| Reb A | 0.015% |
| Vitamin C (Ascorbic Acid) | 0.105% |
| Erythritol | 0.90% |
| Total | 100.000% |

### Example 10

To 225 g gum arabic solution (20%) 3 g vitamin C was added. Fish oil 15 g (22% EPA/DHA) containing dissolved 9 g palm oil was added and emulsified at 10-25° C. under high shear mixing to form an oil-in-water emulsion. Subsequently, 60 g solution of beta-lactoglobulin (5%) was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage containing omega-3 fish oil. The pH was about 2.9. The pH range of the resultant isotonic beverage may be about 2.5-4.5.

TABLE 10

| | Amount |
|---|---|
| Ingredient | (% by wt.) |
| Water | 95.23% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Emulsion | 1.25% |
| Reb A | 0.015% |
| Vitamin C (Ascorbic Acid) | 0.105% |
| Erythritol | 0.90% |
| Total | 100.000% |

### Example 11

To 75 g gum arabic solution (20%) 0.3 g vitamin C was added. Fish oil 7 g (22% EPA/DHA) containing dissolved 3 g SAIB-MCT and 0.19 g butylated hydroxytoluene was added and emulsified at 10-25° C. under high shear mixing to form an oil-in-water emulsion. Subsequently, 20 g solution of beta-lactoglobulin (10%) was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage containing omega-3 fish oil. The pH was about 2.9. The pH range of the resultant isotonic beverage may be about 2.5-4.5.

TABLE 11

| | Amount |
|---|---|
| Ingredient | (% by wt.) |
| Water | 95.59% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Emulsion | 0.89% |
| Reb A | 0.015% |
| Vitamin C (Ascorbic Acid) | 0.105% |
| Erythritol | 0.90% |
| Total | 100.000% |

### Example 12

To 225 g gum arabic solution (20%) fish oil 15 g (22% EPA/DHA) containing dissolved 9 g SAIB-MCT was added. The mixture was emulsified at 10-25° C. under high shear mixing to form an oil-in-water emulsion. Subsequently, 60 g solution (5%) of whey protein isolate (WPI) was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage containing omega-3 fish oil. The pH was about 2.9. The pH range of the resultant isotonic beverage may be about 2.5-4.5.

TABLE 12

| | Amount |
|---|---|
| Ingredient | (% by wt.) |
| Water | 95.24% |
| Dry Sucrose | 1.96% |
| Salt Blend | 0.11% |
| Citric Acid | 0.27% |
| Mango Flavor | 0.100% |
| Yellow #6 Color 10% solution | 0.060% |
| Coacervate Emulsion | 1.24% |
| Reb A | 0.015% |
| Vitamin C (Ascorbic Acid) | 0.105% |
| Erythritol | 0.90% |
| Total | 100.000% |

### Example 13

To 225 g gum arabic solution (20%) orange oil 30 g was added. The mixture was emulsified at 10-25° C. under high shear mixing to form an oil-in-water emulsion. Subsequently, 60 g solution (20%) of beta-lactoglobulin was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage. The pH was about 2.9. The pH range of the resultant isotonic beverage may be about 2.5-4.5.

TABLE 13

| | Amount |
|---|---|
| Ingredient | (% by wt.) |
| Water | 97.43% |
| Dry Sucrose | 2.0% |
| Citric Acid | 0.19% |
| Sodium Citrate | 0.133 |
| Coacervate Emulsion | 0.100% |
| Yellow #6 Color (10% solution) | 0.060% |
| Vitamin C (Ascorbic Acid) | 0.06% |
| Sodium Benzoate | 0.02% |
| Total | 100.000% |

### Example 14

To 225 g gum arabic solution (20%) orange oil 15 g containing 15 g palm oil was added. The mixture was emulsified at 10-25° C. under high shear mixing to form an oil-in-water emulsion. Subsequently, 60 g solution (20%) of beta-lactoglobulin was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage. The pH was about 2.9. The pH range of the resultant isotonic beverage may be about 2.5-4.5.

TABLE 14

| | Amount |
|---|---|
| Ingredient | (% by wt.) |
| Water | 97.43% |
| Dry Sucrose | 2.0% |
| Citric Acid | 0.19% |
| Sodium Citrate | 0.133 |
| Coacervate Emulsion | 0.100% |
| Yellow #6 Color (10% solution) | 0.060% |
| Vitamin C (Ascorbic Acid) | 0.06% |
| Sodium Benzoate | 0.02% |
| Total | 100.000% |

### Example 15

To 225 g gum arabic solution (20%) citral (30 g) was added. The mixture was emulsified at 10-25° C. under high shear mixing to form an oil-in-water emulsion. Subsequently, 60 g solution (20%) of beta-lactoglobulin was added slowly to form coacervate complex emulsion at pH 3-5. The coacervate emulsion was further mixed for 2 minutes and then homogenized by 1-2 pass under 3000-4500 psi. The coacervate emulsion was added to the beverage and dispersed in the beverage. Additional ingredients were added in the concentrations (w/w) listed below to make an isotonic beverage. The pH was about 2.9. The pH range of the resultant isotonic beverage may be about 2.5-4.5.

TABLE 15

| | Amount |
|---|---|
| Ingredient | (% by wt.) |
| Water | 97.43% |
| Dry Sucrose | 2.0% |
| Citric Acid | 0.19% |
| Sodium Citrate | 0.133 |
| Coacervate Emulsion | 0.100% |
| Yellow #6 Color (10% solution) | 0.060% |
| Vitamin C (Ascorbic Acid) | 0.06% |
| Sodium Benzoate | 0.02% |
| Total | 100.000% |

TABLE 16
Omega-3 Fish Oil Stability in Beverage

| Example | Stability (70-75° F.) | Stability (90° F.) |
|---|---|---|
| 1 | at least 2 months (no fish | at least 1 month (no fish |
| | odor and taste) | odor and taste) |
| 2 | at least 2 months (no fish | at least 1 month (no fish |
| | odor and taste) | odor and taste) |
| 3 | at least 2 months (no fish | at least 1 month (no fish |
| | odor and taste) | odor and taste) |
| 4 | at least 2 months (no fish | at least 1 month (no fish |
| | odor and taste) | odor and taste) |
| 5 | at least 2 months (no fish | at least 1 month (no fish |
| | odor and taste) | odor and taste) |
| 6 | at least 2 months (no fish | at least 1 month (no fish |
| | odor and taste) | odor and taste) |
| 7 | at least 2 months (no fish | at least 1 month (no fish |
| | odor and taste) | odor and taste) |

TABLE 17
Stability of Omega-3 Fish Oil in Dairy

| Example | Stability (70-75° F.) | Stability (90° F.) |
|---|---|---|
| 8 | at least 3 month (no fish | at least 1 month (no fish |
| (smoothie, pH 3.5) | odor and taste) | odor and taste) |
| 8 | at least 3 month (no fish | at least 1 month (no fish |
| (shake, pH 7.0) | odor and taste) | odor and taste) |

TABLE 18
Coacervate-Containing Beverage Stability
without Conventional Weighting Agent

| Example | Stability (70-75° F.) | Stability (90° F.) |
|---|---|---|
| 1 | at least 3 months (no ringing | at least 1 month (no ringing |
| | and creaming) | and creaming) |
| 6 | at least 3 months (no ringing | at least 1 month (no ringing |
| | and creaming) | and creaming) |
| 7 | at least 3 months (no ringing | at least 1 month (no ringing |
| | and creaming) | and creaming) |
| 13 | at least 1 month (no ringing | at least 1 month (no ringing |
| | and creaming) | and creaming) |
| 14 | at least 1 month (no ringing | at least 1 month (no ringing |
| | and creaming) | and creaming) |
| 15 | at least 1 month (no ringing | at least 1 month (no ringing |
| | and creaming) | and creaming) |

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. An aqueous dispersion of complex coacervates prepared by a method comprising:
a. providing an aqueous solution of at least one anionic polymer selected from the group consisting of gum arabic, pectin, carrageenan, ghatti gum, xanthan gum, agar, modified starch, alginate, carboxyl methyl cellulose (CMC), Q-200 (National Starch) or combinations thereof;
b. adding water soluble antioxidant and hydrophobic substance to the aqueous polymer solution and high shear mixing to form an emulsion, wherein the water soluble antioxidant is added prior to the high shear mixing;
c. adding to the emulsion at least one cationic polymer selected from the group consisting of whey protein, beta-lactoglobulin, alpha-lactalbumin, whey protein isolate (WPI), whey protein concentrated, hydrolyzed protein, gelatin, corn zein protein, bovine serum albumin, egg albumin, grain protein extracts, e.g., protein from wheat, barley, rye, oats, etc., vegetable proteins, microbial proteins, chitosan, legume proteins, hydrolyzed protein, lauric arginate, polylysine, casein or combinations thereof;
d. high shear mixing to form an aqueous dispersion of complex coacervates.

2. The aqueous dispersion of complex coacervates of claim 1 wherein the at least one hydrophobic substance is selected from lipids, water-insoluble vitamins, water-insoluble sterols, water-insoluble flavonoids, flavours, and essential oils.

3. The aqueous dispersion of complex coacervates of claim 1 wherein the at least one hydrophobic substance comprises fish oil comprising omega-3 fatty acid including at least one of EPA and DHA.

4. The aqueous dispersion of complex coacervates of claim 1 wherein the at least one hydrophobic substance comprises docosahexaenoic acid, eicosapentaenoic aid, stearidonic acid, alpha-linolenic acid, conjugated linoleic acid, or combinations thereof.

5. The aqueous dispersion of complex coacervates of claim 3 wherein the content of EPA/DHA combined in the emulsion is in the range of 0.1-10 wt. %.

6. The aqueous dispersion of complex coacervates of claim 5 wherein the content of EPA/DHA combined in the emulsion is in the range of 1 to 3 wt. %.

7. The aqueous dispersion of complex coacervates of claim 1 wherein the at least one anionic polymer comprises gum arabic.

8. The aqueous dispersion of complex coacervates of claim 7 wherein the concentration of gum arabic is in the range of 1-40 wt. %.

9. The aqueous dispersion of complex coacervates of claim 8 wherein the concentration of gum arabic is in the range of 10 to 20 wt. %.

10. The aqueous dispersion of complex coacervates of claim 1 wherein the at least one cationic polymer comprises beta-lactoglobulin.

11. The aqueous dispersion of complex coacervates of claim 10 wherein the concentration of beta-lactoglobulin is in the range of 0.05-10 wt. %.

12. The aqueous dispersion of complex coacervates of claim 11 wherein the concentration of beta-lactoglobulin is in the range of 1 to 5 wt. %.

13. The aqueous dispersion of complex coacervates of claim 1 wherein the water soluble antioxidant is added to the solution of the at least one anionic polymer before adding at least one hydrophobic substance.

14. The aqueous dispersion of complex coacervates of claim 1 wherein the water soluble antioxidant comprises plant derived antioxidants, such as those derived from blackberries, water soluble polyphenols, or vitamin C.

15. The aqueous dispersion of complex coacervates of claim 14 wherein the water soluble antioxidant comprises vitamin C

16. The aqueous dispersion of complex coacervates of claim 15 wherein the concentration of vitamin C is in the range of 0.01-20 wt. %.

17. The aqueous dispersion of complex coacervates of claim 16 wherein the concentration of vitamin C is in the range of 0.5 to 5 wt. %.

18. The aqueous dispersion of complex coacervates of claim 1 wherein the hydrophobic substance further comprises a water insoluble antioxidant.

19. The aqueous dispersion of complex coacervates of claim 18 wherein the water insoluble antioxidant is selected from butylated hydroxytoluene, butylated hydroxyanisole, tert-butyhydroquinone, quercetin, tocopherol, or combinations thereof.

20. The aqueous dispersion of complex coacervates of claim 1 wherein a stabilizer is added to the hydrophobic substance.

21. The aqueous dispersion of complex coacervates of claim 20 wherein the stabilizer is selected from sucrose ester, triglycerides, lecithin, ester gum, palm oil, vegetable oil or combinations thereof.

22. The aqueous dispersion of complex coacervates of claim 21 wherein the stabilizer comprises ester gum and sucrose ester containing triglycerides.

23. The aqueous dispersion of complex coacervates of claim 1 wherein the at least one anionic polymer is gum arabic, the at least one hydrophobic substance is omega-3 fatty acid, and the at least one cationic polymer is whey protein.

24. The aqueous dispersion of complex coacervates of claim 1 wherein the water soluble antioxidant is added to the solution of the at least one anionic polymer before adding the at least one hydrophobic substance, and wherein a stabilizer is added to the hydrophobic substance before adding the at least one cationic polymer.

25. The aqueous dispersion of complex coacervates of claim 20 wherein the at least one anionic polymer is gum arabic, the at least one hydrophobic substance is omega-3 fatty acid, the at least one cationic polymer is whey protein, the water soluble antioxidant is vitamin C, and the stabilizer is sucrose ester containing triglycerides.

26. A food product comprising:
an aqueous dispersion of complex coacervates combined with at least one additional food ingredient, wherein the aqueous dispersion of complex coacervates is prepared by:
a. providing an aqueous solution of at least one anionic polymer selected from the group consisting of gum arabic, pectin, carrageenan, ghatti gum, xanthan gum, agar, modified starch, alginate, carboxyl methyl cellulose (CMC), Q-200 (National Starch) or combinations thereof;
b. adding water soluble antioxidant and hydrophobic substance to the aqueous polymer solution and high shear mixing to form an emulsion, wherein the water soluble antioxidant is added prior to the high shear mixing;
c. adding to the emulsion at least one cationic polymer selected from the group consisting of whey protein, beta-lactoglobulin, alpha-lactalbumin, whey protein isolate (WPI), whey protein concentrated, hydrolyzed protein, gelatin, corn zein protein, bovine serum albumin, egg albumin, grain protein extracts, e.g., protein from wheat, barley, rye, oats, etc., vegetable proteins, microbial proteins, chitosan, legume proteins, hydrolyzed protein, lauric arginate, polylysine, casein or combinations thereof;
d. high shear mixing to form an aqueous dispersion of complex coacervates.

27. The food product of claim 26 wherein the food product is a beverage.

28. The food product of claim 26 wherein the food product is a carbonated soda beverage.

29. The food product of claim 26 wherein the food product has a pH of 2.5 to pH 5.5.

30. A method for preparing an aqueous dispersion of complex coacervates comprising:
a. providing an aqueous solution of at least one anionic polymer selected from the group consisting of gum arabic, pectin, carrageenan, ghatti gum, xanthan gum, agar, modified starch, alginate, carboxyl methyl cellulose (CMC), Q-200 (National Starch) or combinations thereof;
b. adding water soluble antioxidant and hydrophobic substance to the aqueous polymer solution and high shear mixing to form an emulsion, wherein the water soluble antioxidant is added prior to the high shear mixing;
c. adding to the emulsion at least one cationic polymer selected from the group consisting of whey protein, beta-lactoglobulin, alpha-lactalbumin, whey protein isolate (WPI), whey protein concentrated, hydrolyzed protein, gelatin, corn zein protein, bovine serum albumin, egg albumin, grain protein extracts, e.g., protein from wheat, barley, rye, oats, etc., vegetable proteins, microbial proteins, chitosan, legume proteins, hydrolyzed protein, lauric arginate, polylysine, casein or combinations thereof;
d. high shear mixing to form an aqueous dispersion of complex coacervates.

31. The method for preparing an aqueous dispersion of complex coacervates of claim 30 wherein the water soluble antioxidant is added to the solution of the at least one anionic polymer before adding at least one hydrophobic substance.

32. The method for preparing an aqueous dispersion of complex coacervates of claim 30 wherein the hydrophobic substance further comprises a water insoluble antioxidant.

33. The method for preparing an aqueous dispersion of complex coacervates of claim 32 wherein the water insoluble antioxidant is selected from butylated hydroxytoluene, butylated hydroxyanisole, tert-butyhydroquinone, quercetin, tocopherol, or combinations thereof.

34. The method for preparing an aqueous dispersion of complex coacervates of claim 30 further comprising adding a stabilizer to the emulsion prior to adding the at least one cationic polymer.

35. The method for preparing an aqueous dispersion of complex coacervates of claim 30 wherein the at least one hydrophobic substance is selected from lipids, water-insoluble vitamins, water-insoluble sterols, water-insoluble flavonoids, flavours, and essential oils.

36. The method for preparing an aqueous dispersion of complex coacervates of claim 30 wherein the at least one hydrophobic substance comprises a fatty acid selected from an omega-3 fatty acid, an omega-6 fatty acid, and combinations of any of them.

37. The method for preparing an aqueous dispersion of complex coacervates of claim 30 wherein the at least one hydrophobic substance comprises docosahexaenoic acid, eicosapentaenoic aid, stearidonic acid, alpha-linolenic acid, conjugated linoleic acid, vitamin A, vitamin E, citral, limonene, and extract or oil of orange, lemon, lime, grapefruit, almond, hazelnut, peanut, cherry, apple, strawberry, coffee, mint, vanilla, and any combination thereof.

38. The method for preparing an aqueous dispersion of complex coacervates of claim 30 wherein the at least one anionic polymer is gum arabic.

39. The method for preparing an aqueous dispersion of complex coacervates of claim 30 wherein the water soluble antioxidant is vitamin C.

40. The method for preparing an aqueous dispersion of complex coacervates of claim 34 wherein the stabilizer is selected from sucrose ester, triglycerides, lecithin, and ester gum or the combination thereof.

41. The method for preparing an aqueous dispersion of complex coacervates of claim 40 wherein the stabilizer is sucrose ester containing triglycerides.

42. The method for preparing an aqueous dispersion of complex coacervates of claim 30 wherein the at least one anionic polymer is gum arabic, the at least one hydrophobic substance is omega-3 fatty acid, and the at least one cationic polymer is whey protein.

43. A method for preparing a food product comprising an aqueous dispersion of complex coacervates comprising:
a. providing an aqueous solution of at least one anionic polymer selected from the group consisting of gum arabic, pectin, carrageenan, ghatti gum, xanthan gum, agar, modified starch, alginate, carboxyl methyl cellulose (CMC), Q-200 (National Starch) or combinations thereof;
b. adding water soluble antioxidant and hydrophobic substance to the aqueous polymer solution and high shear mixing to form an emulsion, wherein the water soluble antioxidant is added prior to the high shear mixing;
c. adding to the emulsion at least one cationic polymer selected from the group consisting of whey protein, beta-lactoglobulin, alpha-lactalbumin, whey protein isolate (WPI), whey protein concentrated, hydrolyzed protein, gelatin, corn zein protein, bovine serum albumin, egg albumin, grain protein extracts, e.g., protein from wheat, barley, rye, oats, etc., vegetable proteins, microbial proteins, chitosan, legume proteins, hydrolyzed protein, lauric arginate, polylysine, casein or combinations thereof;
d. high shear mixing to form an aqueous dispersion of complex coacervates; and
e. combining the aqueous dispersion of complex coacervates with a second food ingredient.

44. The method for preparing a food product comprising an aqueous dispersion of complex coacervates of claim 43 wherein the food product is a beverage, dairy, juice, food bar.

45. The method for preparing a food product comprising an aqueous dispersion of complex coacervates of claim 43 wherein the water soluble antioxidant is added to the solution of the at least one anionic polymer before adding at least one hydrophobic substance.

46. The method for preparing a food product comprising an aqueous dispersion of complex coacervates of claim 43 wherein the hydrophobic substance further comprises a water insoluble antioxidant.

47. The method for preparing a food product comprising an aqueous dispersion of complex coacervates of claim 43 further comprising adding a stabilizer to hydrophobic substance prior to adding the cationic polymer.

48. A beverage comprising an aqueous dispersion of complex coacervates in accordance with claim 43, wherein all ingredients are natural.

49. A shelf stable beverage comprising an aqueous dispersion of complex coacervates in accordance with claim 43, wherein the beverage comprises no clouding agent other than aqueous dispersion of complex coacervates in accordance with claim 43.

50. A shelf stable beverage comprising an aqueous dispersion of complex coacervates in accordance with claim 43, wherein the beverage comprises no weighting agent.
